(19) United States
(12) Patent Application Publication
(10) Pub. No.: US 2025/0000082 A1
(43) Pub. Date: Jan. 2, 2025

(54) Device to deform bags for scale-down of freezing and thawing

(71) Applicant: SMARTFREEZ, LDA, Porto Salvo, (PT)

(72) Inventors: Andreia Filipa SILVESTRE DUARTE, Silvares (PT); Rafaela PEREIRA OURO NEVES, Cartaxo (PT); Maria SANTOS PIMENTA FERREIRA TERRUCHA, Arruda dos Vinhos (PT)

(73) Assignee: SMARTFREEZ, LDA, Porto Salvo (PT)

(21) Appl. No.: 18/710,277

(22) PCT Filed: Nov. 15, 2022
(86) PCT No.: PCT/IB2022/060992

§ 371 Date: May 15, 2024

(30) Foreign Application Priority Data
Nov. 15, 2021 (PT) 117575

(51) Int. Cl. A01N 1/02

(52) U.S. Cl. CPC A01N 1/0263

(57) ABSTRACT

The present disclosure describes a device (10) to receive a bag containing a biological product (20), the device acting as a scale-down of a freezing and/or thawing process by preserving the characteristic dimension between scales. The device can be used in the same equipment of the commercial manufacturing scale. The device comprises rims (102) to deform the bag, creating two deformed surfaces (201). The distance between those two deformed surfaces should be the same as the distance between two heat transfer surfaces of a larger bag, this distance being the characteristic dimension of the bag. The device further comprises walls (101) to compress the bag, wherein the walls of the device may act as a tank filled with a solution with similar osmolality of the biological product, or with a phase-change material, to reduce the heat transfer on the walls and promote the main heat transfer through the deformed surfaces of the bag.

### TECHNICAL FIELD

This disclosure relates to a device for compressing and deforming bags containing a biological product for freezing and thawing. In particular, the present disclosure relates to a device for deforming bags while maintaining a specific characteristic dimension for use as a scale-down of freezing and thawing and to be used in the equipment of manufacturing scale.

### BACKGROUND

In the pharmaceutical industry, freezing and thawing processes are essential for the production, storage and distribution of biological products. These processes have several critical points that may compromise the quality and safety of these biological substances, some of which are thermosensitive. Therefore, the freezing and thawing processes must be carefully designed and optimized for each product. When optimizing the processes, several variables needs to be considered, such as the most appropriate cooling (or heating) rates, the ideal formulation to stabilize the biological product, the freezing method, for example, bidirectional or unidirectional freezing, the equipment to be used, amongst others. This optimization process requires several experiments, and, due to the high cost of producing biological substances, these experiments must be carried out with smaller volumes. Therefore, it is desirable to have small volume freeze-thaw processes capable of mimicking large-scale manufacturing process.

To optimize the freezing and thawing processes it is desirable to design a small volume method (a scale-down model) to test the biological product under conditions that are representative of large-scale processing, preferably using the large-scale manufacturing equipment already installed in place. However, it is difficult to optimize the various process parameters that allow small volume biological products to experience the same thermochemical stresses as large-scale volumes during the same freeze or thaw process.

In general, there are two approaches used for scaling down the processes. The first approach is to subject the small container (smaller volume) to the same external conditions as the large container (larger volumes), for example, by placing the two containers in the same freezer. However, due to the significant difference between their dimensions, the same external conditions result in different freezing or thawing rates, leading to a mismatch of local time-temperature profiles between the two scales. The second approach is to improve the agreement of local time-temperature profiles between the two scales by manipulating the external conditions of the small container (scale-down). An example of this approach is manipulating the external process temperature so that the scale-down container freezes or thaws at the same time as the large container. However, this strategy does not consider important factors in the freezing and thawing processes such as natural convection or nucleation (in freezing) which are dependent on the temperature difference established between the container walls and the product inside. Thus, manipulating the external temperature of the processes can result in an equivalent total processing time and similar time-temperature profiles at a given point in the containers, however, significantly different spatial distributions will occur. In other words, the total stress to which biological substances are subjected to on a small scale versus on a large scale is different.

To overcome the limitations of these two previous approaches, the scale-down method should allow the small container to freeze or thaw in the same equipment as the large-scale manufacturing, with less manipulation of small-scale external conditions so that the impact of other operational variables can also be controlled. One of the strategies to develop a scale-down model is by conserving the characteristic dimensions between the small and large containers. For example, U.S. Pat. No. 7,228,688B2 discloses a small bag that maintains one dimension between scales, of the 3 dimensions of the large bag (Celsius). This strategy improves the matches between the scales, however, it relies on auxiliary equipment to implement the freeze/thaw conditions, which could result in different heat transfer coefficients in the heat transfer walls of the small and large containers. A limitation of the strategy of using small-scale systems that retain some characteristic dimensions of the large-scale system is that in flexible containers, such in bags, it is difficult to preserve a characteristic dimension between scales without altering other characteristics. For example, there are systems that freeze bags horizontally in plate freezers. A limitation in the development of scale-down for these systems is to ensure that the heat transfer coefficient on the heat transfer walls, in this case bottom and top bag surfaces, is the same while maintaining the characteristic dimension.

The present disclosure aims to solve the problems mentioned above.

### GENERAL DESCRIPTION

The present disclosure relates to a scale-down device for scale-down freezing and/or thawing of biological product inside a small bag such that the heat transfer coefficient of the heat transfer surfaces of the small bag is the same as the heat transfer coefficient of the heat transfer surfaces of a larger bag when both bags are placed within a manufacturing equipment.

An aspect of the present disclosure relates to a scale-down device for freezing and thawing biological product inside a small bag comprising walls to receive and compress the bag;
rims to deform the bag forming the deformed heat transfer surfaces;
wherein the distance between the two deformed surfaces is the same distance between the heat transfer surfaces of the larger bag (larger scale).

An aspect of the present disclosure relates to a scale-down device for replicating inside a smaller bag the freezing and/or thawing of a biological product inside a larger bag having two heat transfer surfaces at a predetermined distance apart, wherein the smaller bag has a smaller volume relative to the larger bag, comprising:
walls configured to compress the smaller bag; and
rims configured to deform the smaller bag, forming two deformed heat transfer surfaces in the smaller bag, wherein the two heat transfer surfaces of the smaller bag are at a predetermined distance from each other defined by said rims; wherein the predetermined distance between the two heat transfer surfaces of the smaller bag is the same as the distance between corresponding heat transfer surfaces of the larger bag; thus the characteristic dimension of the smaller bag is identical to the characteristic dimension of the larger bag.

A scale-down device for replicating inside a smaller bag the freezing and/or thawing of a biological product inside a larger bag having two heat transfer surfaces at a predetermined distance apart, wherein the smaller bag has a smaller volume relative to the larger bag, comprising:
rims configured to compress the smaller bag; and
walls configured to deform the smaller bag, forming two deformed heat transfer surfaces in the smaller bag, wherein the two heat transfer surfaces of the smaller bag are at a predetermined distance from each other defined by said walls; wherein the predetermined distance between the two heat transfer surfaces of the smaller bag is the same as the distance between corresponding heat transfer surfaces of the larger bag.

In an embodiment, the rim and the walls work together to compress and hold the small bag in order to control the heat transfer.

In an embodiment, the scale-down preserved the characteristic dimension between scales.

In an embodiment, the rims are elongated rings.

In an embodiment, the distance between the two deformed surfaces ranges from 10-200 mm; preferably 20-100 mm.

In an embodiment, the device is designed accordingly to the small bag received, while preserving the characteristic dimension of the larger bag.

In an embodiment, the walls are configured to compress the smaller bag, along the longest axis of the smaller bag (i.e. the length of bag), perpendicularly to the rims to deform the smaller bag.

In an embodiment, the distance between the two deformed surfaces is the thickness of the small bag.

In an embodiment, the rims deform the smaller bag along the shortest axis of the smaller bag (height of the small bag).

In an embodiment, the rims comprise an opening for air flow; preferably an opening that allow the air flow along the length of the small bag. So the hole has a length slightly shorter than the length of the smaller bag.

In an embodiment, the device is made of polymers or materials able to withstand a temperature of −80° C.

In an embodiment, the heat transfer coefficient of the device is less than 5 W/(m²·° C.), preferably less than 2 W/(m²·° C.).

In an embodiment, the walls further comprise a tank; preferably wherein the wall has a opening for filling the tank.

In an embodiment, the tank comprises a solution with an osmolality substantially similar to the osmolality of the biological product in the smaller bag; preferably wherein said solution comprises a phase change material.

In an embodiment, the device can further comprise a lid for placing on top of the rim to cover one of the deformed surfaces of the smaller bag (the top surface of the small bag) in order to promote unidirectional freezing or thawing.

In an embodiment, the lid further comprises an opening (or hole) and a tank that can be filled with a solution with an osmolality substantially similar to the osmolality of the biological product in the smaller bag. In particular, the tank is within the walls and/or within the lid.

In an embodiment, the solution is a phase-change material.

In an embodiment, the length of the walls 101 is shorter than the longer axis of the small bag, allowing the smaller bag to protrude out longitudinally.

In an embodiment, the length of the walls 101 is longer than the longer axis of the small bag, allowing the smaller bag to be longitudinally covered by the walls.

In an embodiment, the device is made of polymers or other materials that have low heat conductivity and high rigidity.

Another aspect of the present disclosure relates to a system comprising a plurality of devices described in the present disclosure, wherein the devices are juxtaposed, in particular the devices being placed with device walls side-by-side.

Another aspect of the present disclosure relates to a method for operating a scale-down device of the present disclosure for replicating inside a smaller bag the freezing or thawing of a biological product inside a larger bag having two heat transfer surfaces at a predetermined distance apart, wherein the smaller bag has a smaller volume relative to the larger bag, the method comprising:
compressing the smaller bag with walls of the scale-down device; and
deforming the smaller bag with rims of the scale-down device, to form two deformed heat transfer surfaces in the smaller bag;
wherein the two heat transfer surfaces of the smaller bag are at a predetermined distance from each other defined by said rims; wherein the predetermined distance between the two heat transfer surfaces of the smaller bag is the same as the distance between corresponding heat transfer surfaces of the larger bag.

Another aspect of the present disclosure relates to a method for operating a scale-down device of the present disclosure for replicating inside a smaller bag the freezing or thawing of a biological product inside a larger bag having two heat transfer surfaces at a predetermined distance apart, wherein the smaller bag has a smaller volume relative to the larger bag, the method comprising:
compressing the smaller bag with rims of the scale-down device; and
deforming the smaller bag with walls of the scale-down device, to form two deformed heat transfer surfaces in the smaller bag;
wherein the two heat transfer surfaces of the smaller bag are at a predetermined distance from each other defined by said rims; wherein the predetermined distance between the two heat transfer surfaces of the smaller bag is the same as the distance between corresponding heat transfer surfaces of the larger bag.

In an embodiment, multiple devices may be configured in juxtaposed configuration. The devices are configured to be juxtaposed so that multiple devices may be used at the same time. The devices in the juxtaposed configuration are placed side by side, more precisely the walls are placed side by side.

### BRIEF DESCRIPTION OF THE DRAWINGS

These and other objects, features and advantages of the disclosure will be evident from the following detailed description when read in conjunction with the accompanying drawings.

For an easier understanding of the disclosure the attached drawings are joined, which represent preferred embodiments of the disclosure that, however, are not meant to limit the object of the present application.

FIG. 1 is an elevated view of a device 10 configured to receive, compress and deform a bag 20, according to the present disclosure.

FIG. 2 is an elevated view of a device 10, according to the present disclosure.

FIG. 3 is an exploded elevated view of a device 10 with tanks 104, according to the present disclosure.

FIG. 4 is an elevated view of another device 10, according to the present disclosure.

FIG. 5 is an elevated view of another device 10, with a cover 105 at the top of a rim 102, for covering a deformed surface of the bag promoting unidirectional freezing/thawing, according to the present disclosure.

FIG. 6 is an exploded elevated view of another device 10, with a cover 105 with a tank 104 for unidirectional freezing/thawing, according to the present disclosure.

FIG. 7 is an elevated view of a device 10 configured to receive, compress and deform a bag, according to the present disclosure.

### DETAILED DESCRIPTION

The present disclosure describes a device to receive a bag to use as a scale-down of freezing and/or thawing process by preserving the characteristic dimension between scales and to be used in the equipment of manufacturing scale. The bag is compressed and deformed to create two deformed surfaces. The distance between those two deformed surfaces should be the same distance between the heat transfer surfaces of a larger bag, this distance is the characteristic dimension of the bag. By preserving the characteristic dimension between scales and using the same freezer/thawer, it can be ensured that the heat transfer coefficient on the heat transfer walls is the same in both scales.

The device of the present disclosure act as a scale-down when using a bag with a volume lower than the bag used at manufacturing scale, while keeping the characteristic dimension and by using the same equipment of the commercial manufacturing scale. This disclosure describes a device with walls to compress a bag and rims to deform the bag forming the deformed heat transfer surfaces.

In an embodiment, the walls of the device may act as a tank that can be fill with a solution with similar osmolality of the biological solution to be used, or with a phase-change material, or similar, to reduce the heat transfer on the walls and promote the main heat transfer through the deformed surfaces of the bag.

In an embodiment, the device of the present disclosure also comprises a lid to place on the top of a rim and cover one deformed surface of the bag, to use for freeze/thaw unidirectional.

As described above, it is necessary to develop tools and systems for scale-down of large systems. It is important that the small container freezes or thaws in the same manufacturing equipment as large-scale manufacturing but with less manipulation of small-scale external conditions, so that the impact of other operational variables can also be controlled. Therefore, the present disclosure describes a scale-down device for bags, that preserves the characteristic dimension between scales, and can be used in the equipment of manufacturing scale.

The present disclosure describes a device for receiving a bag (a small bag), with defined volume capacity. I.e. the small bag is compressed and deformed to create two deformed surfaces. The distance between those two deformed surfaces should be the same distance between the heat transfer surfaces of a larger bag, this distance is the characteristic dimension of the bag. By preserving the characteristic dimension between scales and using the same freezer/thawer, it can be ensured that the heat transfer coefficient on the heat transfer walls is the same in both scales.

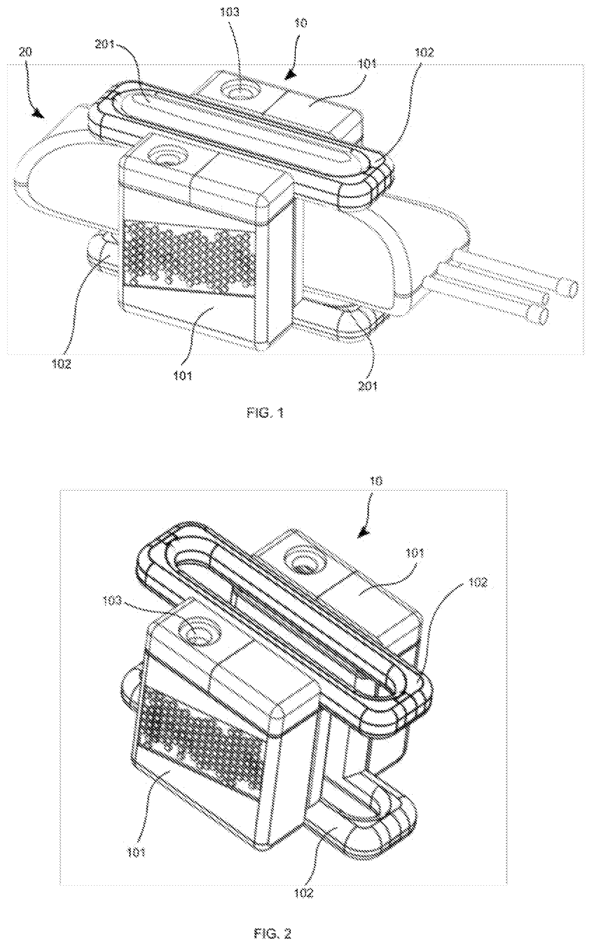

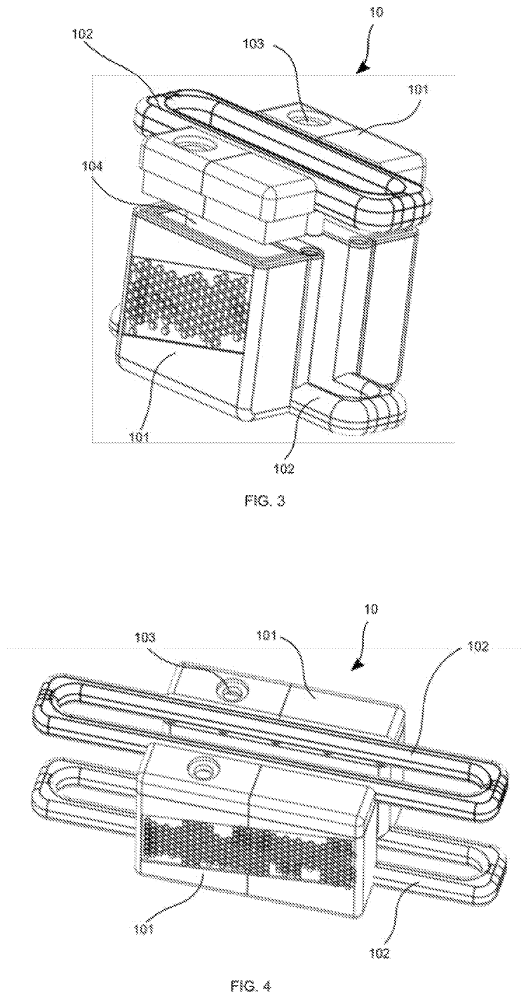

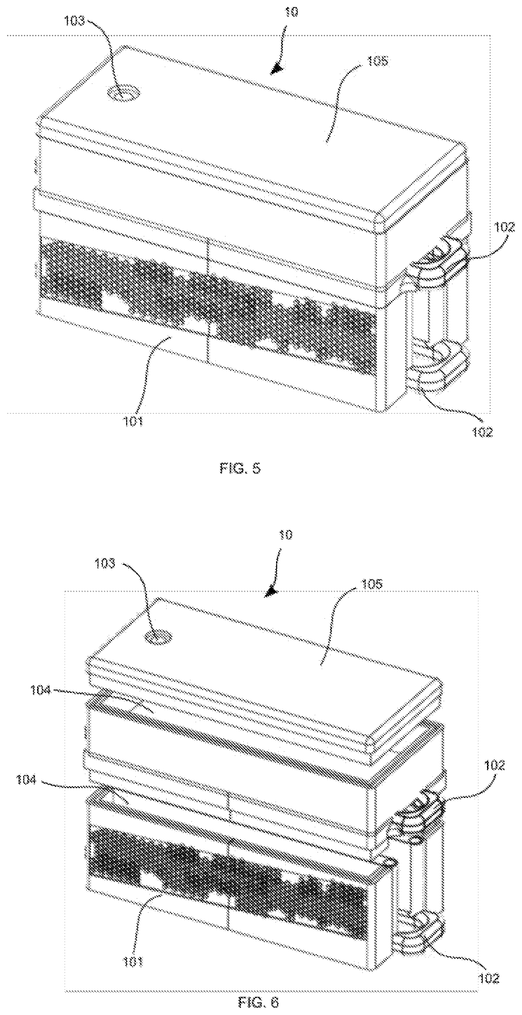

In an embodiment, it is disclosed a device 10 for deforming a bag 20, resulting in deformed surfaces 201. In an embodiment, the device act as a scale-down when using a bag with a volume lower than the bag used at manufacturing scale, while keeping the characteristic dimension and by using the same equipment of the commercial manufacturing scale. (see FIGS. 1 to 7 for example illustration).

In an embodiment, the device 10 has walls 101 to compress the bag 20 and rims 102 to deform the bag forming the deformed heat transfer surfaces 201. In a preferred embodiment, the device 10 is made of polymers or other materials that have low heat conductivity and high rigidity. Preferably, the device 10 is made of materials that maintains its integrity even at low temperatures, as for example −80° C. In an embodiment, the heat transfer coefficient of the device 10, comprising the walls 101 and the rims 102, is less than 5 W/(m²·° C.), preferentially less than 2 W/(m²·° C.). In an alternative embodiment, the device 10 can also have embodiments from any other materials.

In an embodiment, the walls 101 of the device 10 may act as a tank 104 and have a hole 103 to fill the tank. In a preferred embodiment the tanks 104 can be filled with a solution with similar osmolality as the biological product to be used. In an embodiment the tanks 104 can be filled with a phase-change material, or similar. In a preferred embodiment, using a phase-change material in the walls 101 may reduce the heat transfer on the walls 101 and promote the main heat transfer through the deformed surfaces 201 of the bag (see FIGS. 1 to 7 for example illustration).

In another embodiment, the device 10 can be designed according to the bag 20 used. In a preferred embodiment, the device 10 is design to receive a bag, with defined volume capacity, in order to obtain the characteristic dimension desired. (see FIGS. 1 to 7 for example illustration).

In an embodiment, the device 10 is used to freeze/thaw a small bag with the same characteristic dimension of a larger bag, acting as a scale-down. For example, if a larger bag (manufacturing scale) with 5 cm of characteristic dimension is frozen in a horizontal plate freezer, two surfaces of the bag will be in direct contact with the cooling plates, transferring the heat from the plates. The device herein described, can be used as scale-down of the larger bag, using a small volume bag, that when compressed and deformed by the device, will have the same 5 cm of characteristic dimension (distance between the two deformed surfaces), and if placed in the same plate freezer, will have the same heat transfer at the deformed surfaces.

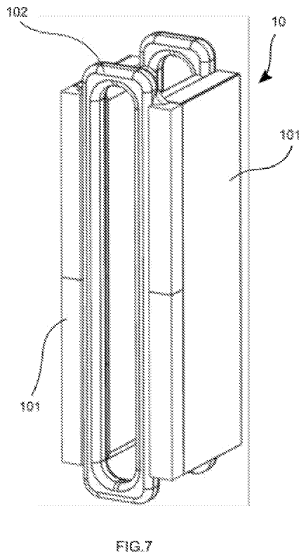

In an embodiment, the device 10 can be used to freeze/thaw unidirectional, for example from bottom to top. In an embodiment, the device 10 may have a lid 105 to place in the top of a rim 102 and cover one deformed surface of the bag 201. In an embodiment the lid 105 may act as a tank 104 and has a hole 103 to fill the tank. In another embodiment, the lid 105 can be filled with a solution with similar osmolality of the solution to be tested, or with a phase-change material, or similar. In a preferred embodiment, using a phase-change material in the lid 105, will reduce the heat transfer on the covered deformed surface 201 and promote the main heat transfer through the other deformed surface of the bag (bottom surface) freezing the bag from bottom to top. (see FIGS. 5 to 6 for example illustration).

In an embodiment, multiple devices may be configured in juxtaposed configuration. The devices are configured to be juxtaposed so that multiple devices may be used at the same time. The devices in the juxtaposed configuration are placed side by side, more precisely the walls are placed side by side.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

The disclosure should not be seen in any way restricted to the embodiments described and a person with ordinary skill in the art will foresee many possibilities to modifications thereof.

The embodiments described above are combinable.

1. A scale-down device for replicating inside a smaller bag the freezing and/or thawing of a biological product inside a larger bag having two heat transfer surfaces at a predetermined distance apart, wherein the smaller bag has a smaller volume relative to the larger bag, comprising:
walls configured to compress the smaller bag; and
rims configured to deform the smaller bag, forming two deformed heat transfer surfaces in the smaller bag, wherein the two heat transfer surfaces of the smaller bag are at a predetermined distance from each other defined by said rims;
wherein the predetermined distance between the two heat transfer surfaces of the smaller bag is the same as the distance between corresponding heat transfer surfaces of the larger bag.

2. A scale-down device for replicating inside a smaller bag the freezing and/or thawing of a biological product inside a larger bag having two heat transfer surfaces at a predetermined distance apart, wherein the smaller bag has a smaller volume relative to the larger bag, comprising:
rims configured to compress the smaller bag; and
walls configured to deform the smaller bag, forming two deformed heat transfer surfaces in the smaller bag, wherein the two heat transfer surfaces of the smaller bag are at a predetermined distance from each other defined by said walls;
wherein the predetermined distance between the two heat transfer surfaces of the smaller bag is the same as the distance between corresponding heat transfer surfaces of the larger bag.

3. The device according to claim 2, wherein the walls are configured to compress the smaller bag, along the longest axis of the smaller bag, perpendicularly to the rims to deform the smaller bag.

4. The device according to claim 1, wherein the distance between the two deformed surfaces is the thickness of the smaller bag.

5. The device according to claim 1, wherein the distance between the two deformed surfaces ranges from 10 mm to 200 mm.

6. The device according to claim 1, wherein the rims deform the smaller bag along the shortest axis of the smaller bag.

7. The device according to claim 2, wherein the rims comprise an opening for air flow.

8. The device according to claim 1, wherein the device is made of polymers or materials able to withstand a temperature of −80° C.

9. The device according to claim 1, wherein the heat transfer coefficient of the device is less than 5 W/(m²·° C.).

10. The device according to claim 1, wherein the walls further comprise a tank.

11. The device according to claim 10, wherein the tank comprises a solution with an osmolality substantially similar to the osmolality of the biological product in the smaller bag.

12. The device according to claim 1, further comprising a lid for placing on top of the rim to cover one of the deformed surfaces of the small bag.

13. The device according to claim 12, wherein the lid further comprises a tank.

14. The device according to claim 1, wherein the lid tank comprises a solution with an osmolality substantially similar to the osmolality of the biological product in the small bag.

15. The device according to claim 1, wherein the length of the walls is shorter than the longer axis of the smaller bag, allowing the smaller bag to protrude out longitudinally.

16. The device according to claim 1, wherein the length of the walls is longer than the longer axis of the smaller bag, allowing the smaller bag to be longitudinally covered by the walls.

17. A system comprising a plurality of devices according to claim 1, wherein the devices are juxtaposed such that the device walls are side-by-side.

18. A method for operating a scale-down device according to claim 1, for replicating inside a smaller bag the freezing or thawing of a biological product inside a larger bag having two heat transfer surfaces at a predetermined distance apart, wherein the smaller bag has a smaller volume relative to the larger bag, the method comprising:
compressing the smaller bag with walls of the scale-down device; and
deforming the smaller bag with rims of the scale-down device, to form two deformed heat transfer surfaces in the smaller bag;
wherein the two heat transfer surfaces of the smaller bag are at a predetermined distance from each other defined by said rims; wherein the predetermined distance between the two heat transfer surfaces of the smaller bag is the same as the distance between corresponding heat transfer surfaces of the larger bag.

19. A method for operating a scale-down device according to claim 18, for replicating inside a smaller bag the freezing or thawing of a biological product inside a larger bag having two heat transfer surfaces at a predetermined distance apart, wherein the smaller bag has a smaller volume relative to the larger bag, the method comprising:
compressing the smaller bag with rims of the scale-down device; and
deforming the smaller bag with walls of the scale-down device, to form two deformed heat transfer surfaces in the smaller bag;
wherein the two heat transfer surfaces of the smaller bag are at a predetermined distance from each other defined by said rims; wherein the predetermined distance between the two heat transfer surfaces of the smaller bag is the same as the distance between corresponding heat transfer surfaces of the larger bag.
